(19) United States
(12) Patent Application Publication
(10) Pub. No.: US 2004/0111195 A1
(43) Pub. Date: Jun. 10, 2004

(54) Systems and methods for marine satellite monitoring

(76) Inventors: Jeroen Joost de Vries, Greensboro, NC (US); Mike Meyer, Chesapeake, VA (US); Andy Turnbull, High Point, NC (US); Eddie Szilagyi III, Virginia Beach, VA (US); Michael Gudmunds, Vastra Frolunda (SE); Per Kaiser, Goteborg (SE); Esbjorn Sjoberg, Kungalv (SE); David Sward, Stittsville (CA); Tom Richter, Summerfield, NC (US); Noah Gates, Tobaccoville, NC (US); Michael Siebert, Jamestown, NC (US); Dara Holmes Heed, Goteborg (SE); Denis D'Souza, Kernersville, NC (US); David Roscoe, Kanata (CA)

Correspondence Address: HOWREY SIMON ARNOLD & WHITE LLP, BOX 34, 1299 PENNSYLVANIA AVENUE NW, WASHINGTON, DC, 20004, US

(21) Appl. No.: 10/453,931

(22) Filed: Jun. 4, 2003

Related U.S. Application Data
(60) Provisional application No. 60/387,440, filed on Jun. 11, 2002.
(60) Provisional application No. 60/421,068, filed on Oct. 25, 2002.

(51) Int. Cl. G06F 17/00

(52) U.S. Cl. 701/21; 701/213

(57) ABSTRACT

The invention includes a marine telematics system comprising a satcom unit on a boat, a user interface for the satcom unit, a web-based user interface for the telematics system, and a land-based center of operations. The land-based center of operations receives signals from the satcom unit on the boat about the location of the boat and sensor responses to detectable events. The marine telematics system is customizable through a web-based interface, allowing boat owners to provide information and instructions to the land-based center of operations for handling particular situations that may arise while the boat is in use or at dock. The web-based interface further allows boat owners to plan voyages by setting series of waypoints, and the land-based center of operations may assist the boat owners by providing feedback during their voyages based on the waypoint information previously provided by the boat owners. The marine telematics system of the invention allows users to remotely monitor the location of boats and events detected on boats, and to remotely activate equipment on boats.

### RELATED APPLICATIONS

This application claims priority to U.S. Provisional Patent Application Ser. Nos. 60/387,440, filed Jun. 11, 2002, and 60/421,068, filed Oct. 24, 2002, both applications incorporated herein by reference.

### FIELD OF THE INVENTION

The invention relates to systems and methods for managing information relating to boats, marine accessories and engines, and boating applications, and to providing services for boaters. In particular, this invention relates to a service for tracking information relating to the location and condition of boats, as well as other information useful to boaters.

### BACKGROUND OF THE INVENTION

Global Positioning Systems (GPS) are worldwide satellite based navigation systems that allow accurate location of a GPS receiver. GPS has found extensive use in automobiles, in which the technology is used to pinpoint a driver's location on a street or highway map. GPS has also been extensively used in marine navigation, largely replacing older methods of navigation. GPS has been combined with various communication technologies in an industry known as telematics.

GPS has been combined with a number of other services in many automobiles. For example, the OnStar® system is a telematics system that provides services including emergency services, stolen vehicle tracking, remote diagnostics, personal concierge services, and driving directions. However, land-based telematics services lack many features that would be needed to adapt these systems to marine environments. For example, many land-based systems rely on cellular networks, but there are vast stretches of water in which cellular communications are not possible because they are too remote from any cellular towers. Furthermore, electronics in automobiles run off of car batteries, which are charged using the car's alternator, thus electrical power is as available as gasoline. A similar situation is present on boats, except that fuel is less readily available, especially on long voyages. Thus a boat-based system should be more power efficient than an automobile-based system need be. The need for reliability in marine applications is much more dire than for automobile applications because the consequences of failure can more often be lethal in marine environments.

There are many features that would be necessary or desirable in a marine telematics system that are not present in land based telematics systems. For example, there is a need in marine telematics systems for simple communications that are not based on cellular communications systems. There is a need in marine telematics systems to notify specific and predetermined individuals in case of emergencies or malfunctions. Furthermore, it would be desirable in marine telematics systems for a boat owner to have control over the monitoring and reporting available in such systems.

There is a need in the boating industry for a marine telematics system that boaters can rely on for a number of incidents and emergencies. For example, if a boater runs aground, runs out of fuel, encounters a mechanical failure, has a medical emergency, encounters bad weather, loses power, is taking on water, or is confronted with piracy, there is a clear need for an immediate response. The boater requires a simple and reliable means for contacting a source of help. Furthermore, boaters who get lost or require directions have a need for a system that can pinpoint their position on a map and that can provide instructions for reaching their destination or a safe harbor. There is also a need for boat tracking systems in case a boat is stolen.

### SUMMARY OF THE INVENTION

The invention provides systems and methods for control over the monitoring and reporting features available in a marine telematics system. The invention provides a web-based interface that can be used by boat owners or users, or their friends and family, to set options within the system, and to monitor the location of boats remotely. The invention provides a unique monitoring and notification system that is specifically directed to the needs of boat owners and users. The invention further provides a simple interface for rudimentary communications that is both intuitive and informative.

The marine telematics system of the invention may include components that ensure a boater's safety by providing support in the case of emergencies and guidance in case the boater becomes lost. Boat owners acquire peace of mind when using the invention because it may ensure against theft, can detect incidents such as water leakage or loss of electrical power, and can provide the assurance of always having someone knowing where the boat is. In one aspect, the invention further provides convenience to boat owners by providing a concierge service in which a remote operator can contact port services on behalf of a boater.

In one embodiment, the invention includes a marine telematics system comprising a satcom unit on a boat for receiving GPS transmissions to determine the position of the boat and for sending and receiving signals to a land-based center of operations. The signals may be any kind of signal, including signals that indicate the position of the boat, as determined by the GPS transmissions. The signals may also include speech or text signals from the boater to the land- based center of operations or speech or text signals from the land-based center of operations to the boater. The invention may further include a computer connected to a communications network for use by the boat's owner or the boat's owner's friends and family. Information about the boat's position and status may be stored in a database that may be accessible by the computer over the communications network. In one embodiment, information from the computer is received over the communications network and stored in a database. This information may include information provided by the boat owner or other users of the boat, including coordinates of waypoint locations, or coordinates that specify a geofence, or an area which the boat may not enter or leave (depending on whether the boat starts in the area) without triggering a signal. In one aspect, the information received over the communications network includes instructions for responding to events on the boat including high water, low voltage, or the boat leaving a specified geofence area. Instructions for responding to such events include contacting a dockmaster, contacting the boat's owner, and contacting a local emergency response authority, such as the harbor police or the Coast Guard.

In another embodiment, the invention includes a method for providing telematics services to boaters comprising the steps of receiving signals at a land-based center of operations from a boat equipped with a satcom unit, where the signals include information about the boat's position; sending signals from the land-based center of operations to the boat indicating that the signals from the boat have been received; and updating a database containing information about the position of the boat. The method may include transmitting spoken messages between the boat and the land-based center of operations. The method may further comprise receiving data from a remote user over a communications network. The data may include trip planning information such as the coordinates of waypoints, or the data may indicate the coordinates of a geofence. The data may include instructions for responding to events on the boat that are detected by one or more sensors on the boat. The detected events may include, but are not limited to, high water, low voltage, or the boat leaving a specified geofence area. The instructions for responding to these events may include contacting the boat owner, contacting the dockmaster, or contacting a local emergency response authority, such as the harbor police or the Coast Guard.

In one embodiment, the invention includes a system and method for remotely controlling equipment on a boat. A satcom unit on a boat may receive signals from a land-based center of operations, wherein the signals indicate that a system on the boat should be activated or deactivated. The satcom unit may be operably connected to one or more systems on the boat including but not limited to air conditioning or heating systems, refrigeration systems, the boat engine, or any other system on the boat. Preferably, a boater may remotely access a boat's systems through a web-based interface.

In one aspect, the invention includes a pre-install kit for a marine telematics system comprising a removable panel and a communications cable. The removable panel may be installed on a boat in a location intended for an operator module to control a satcom unit. The communications cable may extend from the removable panel to a location on the boat reserved for the satcom unit.

### DESCRIPTION OF THE FIGURES

FIG. 1A is a front view of one embodiment of the operator module.

FIGS. 1B and 1C are front views of another embodiment of the operator module having a text display window.

FIGS. 2A and 2B are rear views of the operator modules.

FIG. 3 is a side view of one embodiment of the satcom unit.

FIG. 4 is a front view of a telematics interface unit.

FIGS. 5A and 5B are schematic diagrams detailing how embodiments of the invention may be connected to various components.

FIGS. 6A and 6B are examples of home pages of a web site that may be used with the invention.

FIG. 7 is a personal profile page of a web site that may be used with the invention.

FIG. 8 is a waypoints mapping page of a web site that may be used with the invention.

FIG. 9 is a saved trips page of a web site that may be used with the invention.

FIG. 10 is a flow diagram of a method of the invention.

FIG. 11 is a flow diagram of a method of the invention.

### DETAILED DESCRIPTION OF THE INVENTION

The invention includes a marine telematics system with an operator module mounted on a boat as a control panel for an onboard marine satcom unit. The operator module may be connected to one or more of the boat's systems in order to provide information to the boater and to a remote operator. The operator module may also be connected to the marine satcom unit for determining the position of the boat and for sending and receiving transmissions from a remote operator.

The marine telematics system of the invention may comprise any combination of six components. First, a signal carrier and boat connectivity component allows communication between the satcom unit and a land-based center of operations. Second, an engine, helm, and electronics connectivity unit allows monitoring of the boat systems and may include connections for reporting on these systems to the operations center. Third, a web interface may provide a means for controlling options within the system, as well as a means for tracking boats. The web interface can be designed to display advertising or promotional materials from the retailer who sold the boat containing the marine telematics system of the invention, of the manufacturer of the telematics system, or of any third party. Fourth, a voice interface may provide a means for controlling aspects of the system using voice commands and may also provide a voice communications system. Fifth, a service component may provide the user of the marine telematics system with personal or on-line installation and troubleshooting support. Sixth, the system may include automated billing and membership management services.

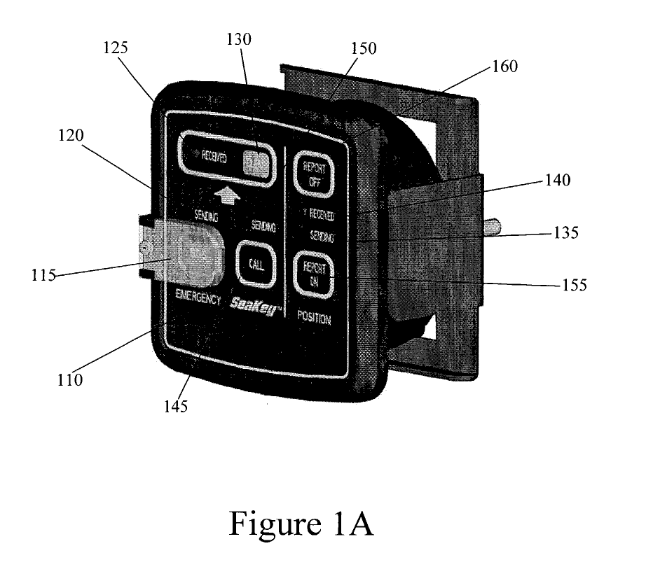

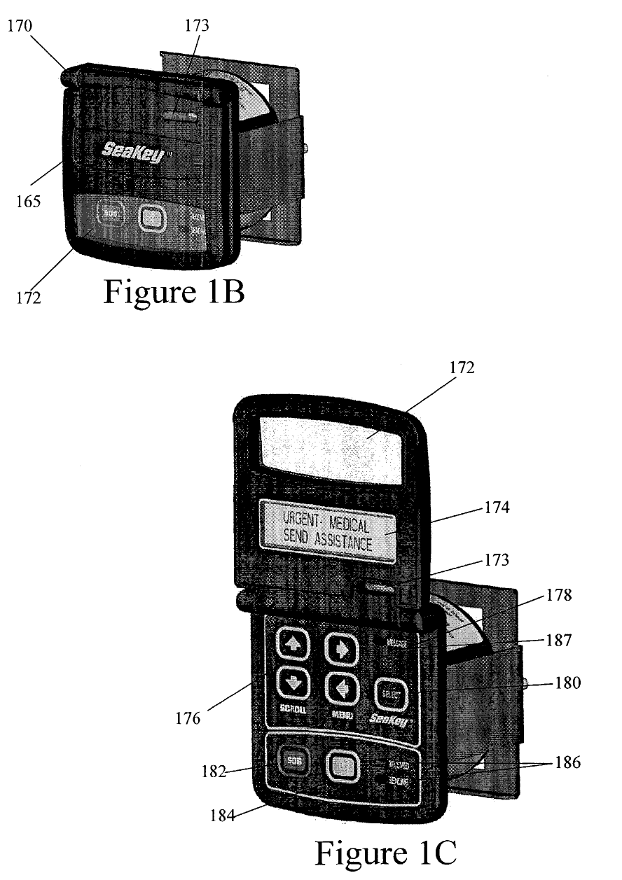

One aspect of the invention includes an operator module, an embodiment of which is depicted in FIG. 1A. The operator module may be mounted on the boat, for example in the cabin or at the helm, preferably in an easily accessible place. It may be made of, for example, injection molded polycarbonate with a textured finish. The operator module may include an emergency button 110 which may be used by boaters in case of any sort of emergency that the boaters think they cannot handle alone. In order to avoid accidental depression of the emergency button 110, the operator module may include a break away cover 115, which a distressed boater must remove before the emergency button 110 can be pressed. The break away cover may be made of, for example, acrylic. Preferably, the break away cover 115 is easily broken away by pulling on a pull-tab or any other suitable means. In alternative embodiments, instead of a break away cover, the emergency button 110 may be covered by a spring-loaded plastic cover that should be lifted in order to access the emergency button 110. In still other embodiments, the emergency button 110 is not covered. Preferably, the switch closed by the button implements a de-bounce circuit to prevent the switch from opening again immediately after it has closed, thus preventing erroneous switching.

When the emergency button 110 is pressed, a visual signal 120 and/or an auditory signal may be provided to the user to indicate that the switch has been successfully closed, and thus that the emergency transmission is being sent. For example, the visual signal 120 may be a flashing red LED backlit illumination of the word “sending”. Preferably, the button 110 is pressed and held for a time, e.g., a half second, before the button 110 is registered and the signal sent, in order to prevent sending a signal when the button 110 is accidentally pressed for a shorter time. When the land-based system operator receives the transmitted emergency signal, the operator sends a signal back, indicating receipt. When the receipt signal has been received, a visual signal 125 and/or auditory signal may be provided to the user to indicate that the land-based system operator has received the emergency transmission. For example, the visual signal 125 may be a solid green LED backlit illumination of the word “received”. Preferably, when the “received” indicator 125 is lit, the flashing red “sending” indicator 120 LED is extinguished. Preferably, the “received” indicator 125 remains lit until the clear button 130 is depressed, for example, for two seconds.

Pressing the emergency button 110 may automatically activate an automated position report function. The automated position report function may then send a report of the boat's position to the land-based system operator. Preferably, the position of the boat is reported periodically, for example, every ten minutes. Preferably, when the automated position report function is activated, position report LEDs 135 and 140 become operational for visual indication of successful GPS messaging. In a preferred embodiment, even if an operator depresses the clear button 130, thus extinguishing any lights, the automated position report function continues until cleared by the land-based system operator. This prevents the position signaling from the boat from being interrupted in case the boat has been illegally boarded.

The operator module may include a position report panel comprising a report on button 155, a report off button 160, and sending 135 and receiving 140 indicator lights. When the user depresses the “report on” button 155, a de-bounced switch may initiate the transmission of a GPS position report. Preferably, the button 155 is pressed and held for a time, e.g., a half second, before the button 155 is registered and a signal sent, in order to prevent sending a signal when the button 155 is accidentally pressed for a shorter time. The position report may be periodically transmitted, for example, every 30 minutes. A “sending” visual and/or auditory indicator that the switch has been successfully closed is provided, for example by flashing red LED 135 to indicate that the system is sending a position signal. When the land-based system receives the position signal, a return signal is sent to the boat, indicating the receipt of the position signal. When this receipt signal is received by the system on the boat, a “received” visual and/or auditory indicator may be provided, for example, a solid green LED 140 may be lit for a time, e.g., for three minutes after each position report. Preferably, when the receipt signal is received and the “received” visual indicator 140 is lit, the “sending” visual indicator 135 ceases to be lit.

In one embodiment, after three minutes from the receipt signal, the green 140 and red 135 LED indicator buttons flash until the next position transmission to indicate that the report position function is still active. When the position report function is activated by pressing the “report on” button 155, a periodic report of the boats position is sent to the land-based system, enabling on-line tracking of the boat and/or tracking by the land-based center of operations, and/or tracking by an emergency response authority. When the “report off” button 160 is pressed, the periodic reporting may be canceled. Preferably, the button 160 is pressed and held for a time, e.g., a half second, before the button 160 is registered in order to prevent turning off the position reporting function when the button 160 is accidentally pressed for a shorter time. The “report on” and “report off” buttons may be used together if the user desires to record the boat's position only at particular way points.

The operator module may further comprise a call button 145. Like the other buttons on the operator module, the call button 145 may activate a switch implementing a de-bounce circuit to prevent erroneous switching. Preferably, the button 145 is pressed and held for a time, e.g., a half second, before the button 145 is registered and a signal sent, in order to prevent sending a signal when the button 145 is accidentally pressed for a shorter time. The call function may activate a “sending” visual indicator 150. For example, the word “sending” 150 above the call button 145 may be backlit by a fiber optic to indicate a message is being sent to the land-based system operator.

Once the message has been received, the land-based system operator can send a receipt signal. When the receipt signal has been received, a visual signal 125 may be provided to the user to indicate that the land-based system operator has received the call request transmission. For example, the visual signal 125 may be a solid green LED backlit illumination of the word “received”. Preferably, when the “received” indicator 125 is lit, the flashing red “sending” indicator 150 LED is extinguished. The “received” indicator 125 may remain lit until the clear button 130 is depressed, until a certain predetermined amount of time has passed, or until the land-based system operator sends another signal, indicating that the desired task has been performed.

The operator module may further include a microphone and speaker (not shown) for spoken communications with a land-based system operator, for example, via satellite or cellular communications. Satellite communication (whether geostationary or low earth orbit) is preferable because satellite coverage is much more complete in the open sea than cellular. The spoken communication aspect of the invention is considered particularly useful for the call and emergency functions of the operator module. For example, the call button may be used to indicate the boater's desire to have a land-based system operator call the boater so that the boater may request some service of the operator, such as making reservations at a dockside restaurant. The boater's request is thus facilitated by a system allowing spoken communication, allowing land-based system operators to perform a concierge function. The emergency function can likewise be enhanced by spoken communication, as a boater can explain the nature of the emergency, thus allowing an emergency response authority to respond appropriately.

FIGS. 1B and 1C depict an alternative embodiment of the operator module having a text window 174 for displaying messages. The operator module may have a flip-top cover 165 attached to the module by a spring-loaded hinge 170. The cover 165 may include transparent windows (172, 173) to allow a boater to see whether the “sending,” “receiving,” (186) and/or “message” (187) LEDs are lit. The operator module may include buttons 176 for scrolling through text appearing in the text window 174 and buttons 178 for scrolling through menu options. The operator module may additionally include a button 180 for selecting a function. The scrolling 176, menu 178, and select 180 buttons may be used together with the text window 174 to provide all of the functionality of the module described in FIG. 1A, as well as additional functionality, as described further below. The operator module may further include emergency 182 and clear 184 buttons, used as described above with respect to FIG. 1A.

The operator module depicted in FIGS. 1B and C allows enhanced communications ability over the simpler unit depicted in Figure 1A. It allows the land-based operations center to send text messages to the boater via satellite data transmission. When a text message has been received, the “message” LED 187 is lit to alert the boater to the message. The text message sent to the boater can be from a land-based operator, for example, to communicate a warning or other useful message, or it can be from a friend or family member who wishes to communicate with the boater. A web-based interface described below allows a friend or family member to provide a text message, which is transmitted via a communications network to the land-based operations center, which then forwards the message via satellite to the satcom unit on the boat, then on to the operator unit, where the message appears in the text window 174.

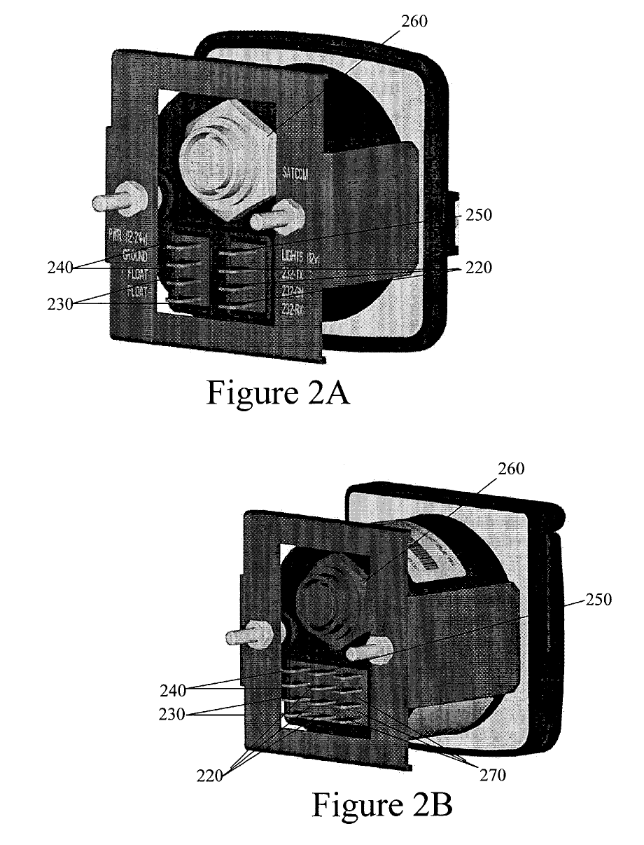

In one embodiment, the operator module depicted in FIGS. 1B and C also allows the boater to communicate with the land-based operations center or with friends or family via text messages. The boater may select one of a preset number of canned text messages to send using the scroll 176, menu 178, and select 180 buttons. These canned text messages may be preset by the boater before the voyage by typing messages in a web-based interface. The boater may then select from among the pre-set canned messages, or from among a number of default standard messages, e.g., announcing an emergency. In another embodiment, the operator unit may further comprise a keypad (not shown) that allows composition of text messages while the boater is underway, which may then be sent in the same manner as any canned messages. In yet another embodiment, the text messaging function is supplemented with a speaker and microphone, allowing satellite or cellular transmission of spoken communications. In a preferred embodiment, the system prioritizes messages such that emergency messages to the boat are displayed before non-emergency messages, and emergency messages from the boat are sent to the land-based control center before non-emergency messages.FIG. 2A shows the rear portion of an embodiment of the operator module corresponding to FIG. 1A. The operator module may include RS-232 communications ports 220 for an engine monitoring interface. Alternatively, the communications ports 220 may be used for any auxiliary functions. The boat's battery may be connected to the power terminals 240, allowing the system to monitor the battery's voltage and to thus send a low voltage alarm when the battery voltage drops below some predetermined threshold level. The operator module may include an additional terminal 250 for a separate power supply to the module to provide a fiber-optical back-light for the operator unit to allow operation under low-light level conditions. The operator module may include terminals 230 for connecting to a water level sensor. When the water level sensor detects that a water level in the bilge area where it should not be, indicating that the boat is taking on water, it may send a signal to the operator module, which may then trigger an on-board alarm, or may send a signal to the land-based system. The operator module may include a connector port 260 for connecting the operator module to a satcom unit.

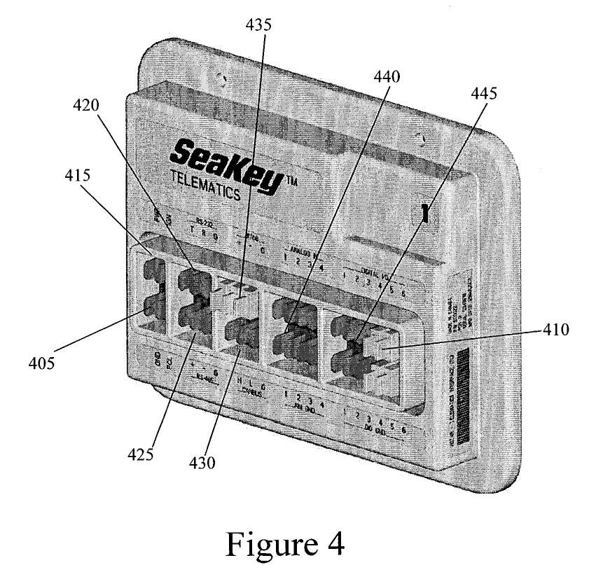

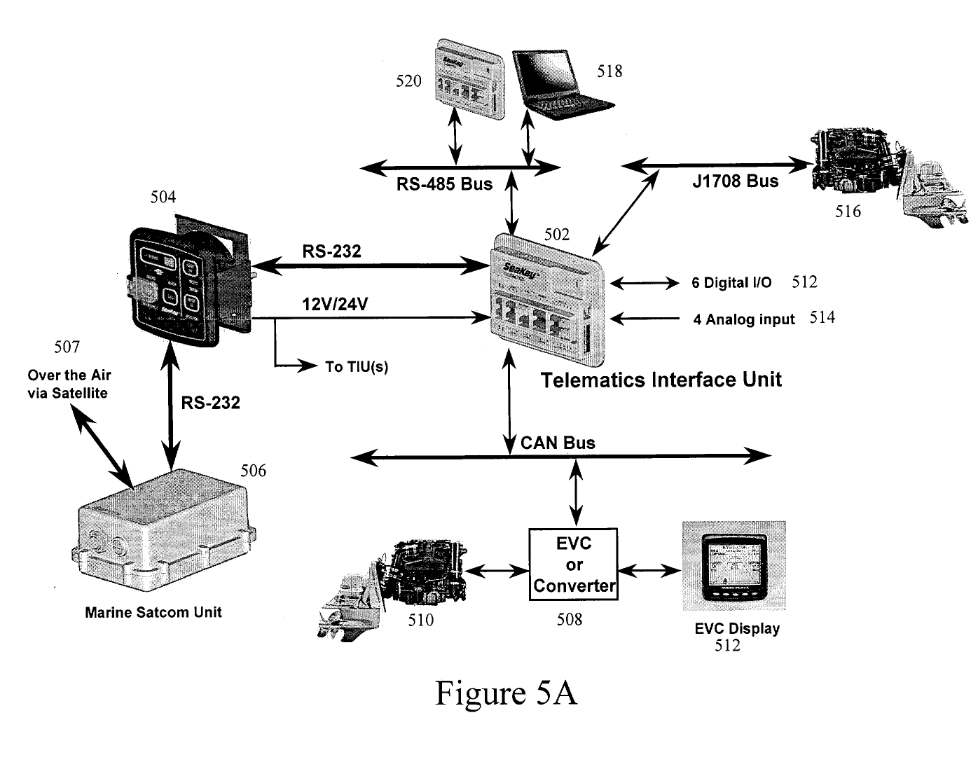

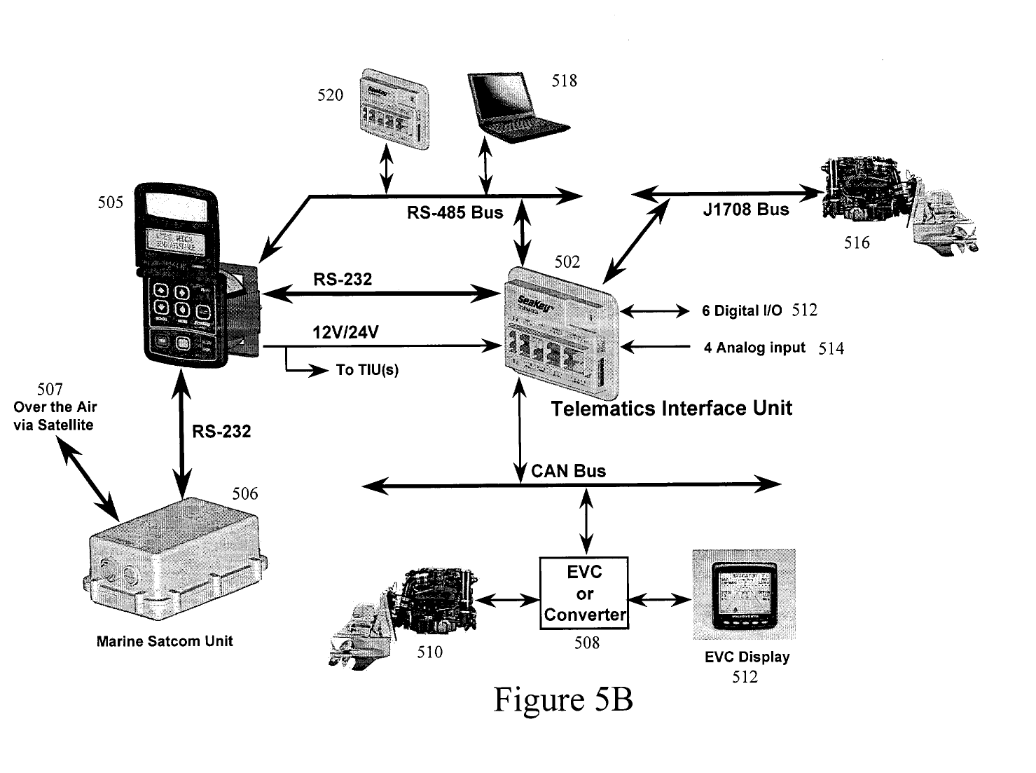

FIG. 2B shows the rear portion of an embodiment of the operator module corresponding to FIG. 1B and C. This embodiment includes RS-132 communications ports 220, power terminals 240, water level sensor terminals 230, and a connector port 260, as described above. This embodiment may additionally include RS-485 communications ports 270 for communications between the operator module and a telematics interface unit (TIU), described below in FIGS. 4 and 5.

It should be noted that while two embodiments of the operator module are described above with reference to FIGS. 1 and 2, these embodiments are examples only. Almost any device that can receive input from and/or display output to a user could serve as an operator module. For example, the operator module could be a computer such as a laptop computer, or a handheld device such as a PDA.

The invention provides a low voltage monitor that may be used either when a boat is at sea or when docked. This feature of the invention provides a warning mechanism to alert the boat's user that necessary electrical functions of the boat, such as lights or an electric bilge pump, may become unavailable unless the battery is recharged. The user may set a preferred means for notification when the low voltage monitor is triggered by setting a preference at a web site. For example, the user may indicate a preference to be notified by telephone, pager, email, or SMS that the low voltage monitor has triggered a low voltage alarm. This notification allows the user to take any necessary steps to ensure that the boat will have a properly functioning battery the next time it is taken out. Alternatively, the user may specify an action that should be performed based on the location of the boat. For example the user may specify that the dockmaster should be contacted and asked to charge the battery when the boat is docked, but a marine rescue service should be contacted and asked to assist if the boat is at sea. Additionally, when the land-based control center receives a signal that the boat's battery's voltage is low, it may update a database to reflect this fact. Thus when a boat owner accesses the database, for example through a web page, the owner is alerted to the fact that the boat's battery's voltage is low. The on-boat components of the system may additionally include an audible and/or visual alarm indicating low voltage.

Similarly, the invention provides a high water monitor that may likewise be used either when a boat is at sea or when docked. This feature of the invention provides a warning mechanism to alert the boat's user that the boat may be taking on water. If the water level becomes too high, the high water monitor may send a signal to the land based system, which then notifies the user according to some pre-arranged communication means such as by satellite or cellular telephone, pager, email, or SMS, as specified by the user by setting a preference at a web site. Alternatively, the user may specify an action that should be performed based on the location of the boat. For example the user may specify that the dockmaster should be contacted and asked to tend to the leak if the boat is docked, but a marine rescue service should be contacted and asked to assist if the boat is at sea. Additionally, when the land-based control center receives a high water signal, it may update a database to reflect this fact. Thus when a boat owner accesses the database, for example through a web page, the owner is alerted to the fact that the boat has taken on water. The on-boat components of the system may additionally include an audible and/or visual alarm indicating high water.

Other alarms and signals may additionally be connected to the system and communications involving these other alarms and signals may be handled in the same way as the low voltage and high water alarms. For example, the system may monitor the engine functions, the drive and gearbox, air-conditioning, illumination, and/or the generator set (gen-set), which provides the vessel with AC and DC power when the engines are not running or may provide auxiliary power when the engines are running. Additionally, the system may monitor carbon monoxide, fire, deck vibration, intrusion, or excessive acceleration or deceleration, and trigger corresponding alarms, either on-board or to the land-based system, or both. The system may also include a signal or alarm that is triggered when the boat leaves some predetermined area. For example, if the boat leaves the region of the port in which it is docked, the land-based system may notify the owner and/or the authorities that the boat is being used without the owner's authorization. This alarm may be “set” each time the owner or an authorized user is finished using the boat and leaves it at a dock.

A further feature may include the ability to set a “geofence” or radius about a fixed location, along with an alarm feature if the boat leaves the area bounded by the geofence. The user may use this feature, for example, to set a boundary for authorized use. For example, if parents who own a boat allow their children to operate the boat, they may set a boundary that the children must stay within. If the boat leaves this boundary, the system may send a notification to the parents through any means specified by the parents. Or a boat owner may make the boat available for rental, but may wish to set limits on how far from a harbor renters may take the boat. The owner may simply specify a geofence boundary, and can be notified by some predetermined means if the boat crosses that boundary. This feature may also allow the owner to set the geofence such that the boat to be moved within the vicinity of a dock as required by the dockmaster without triggering an alarm, but the alarm would be triggered if the boat left the vicinity of the dock to indicate a possible theft.

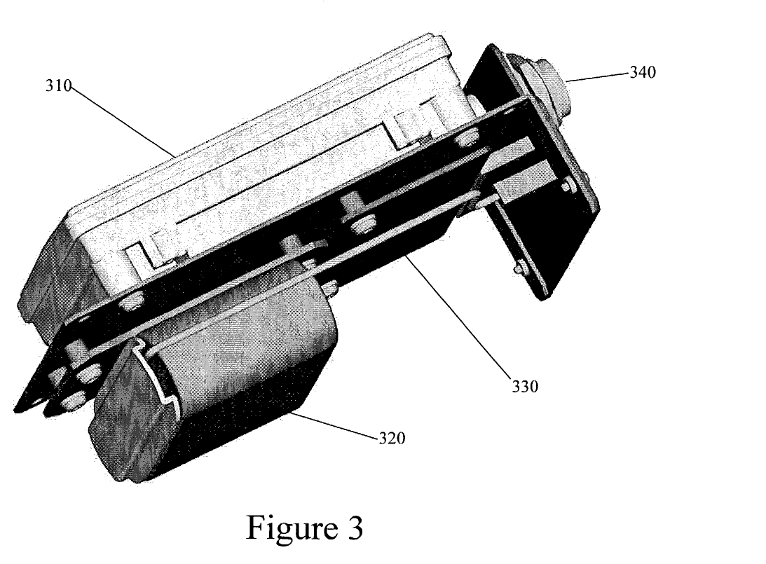

FIG. 3 shows an embodiment of the satcom unit. The satcom unit may include a satellite terminal 310 for sending and receiving information from GPS satellites. The satellite terminal 310 may additionally provide a means for sending and receiving communications via communications satellites. The communications can be text, data, spoken, or any other form of communication. The satcom unit may include a battery pack 320 for powering the satcom unit. Preferably, the battery pack 320 comprises a rechargeable battery such as a sealed lead acid battery for powering the satcom unit when the boat's battery is disconnected or too low. The battery pack 320 is preferably recharged by the boat's battery power system. The battery pack 320 can provide an independent power source, thus allowing the system to operate when boat power is removed or disabled. The satcom unit may include an expansion card 330 for upgrades. The satcom unit may include a connector port 340 for connecting the satcom unit to the operator module.

FIG. 4 shows a telematics interface unit (TIU) for use with the system of the invention. The TIU has a series of brass conductor terminals 405 for connection to a power source 415 and with other system components. Unused terminals can be capped by a non-conductive cover 410. The TIU can provide CAN2.0B monitoring through pins 430 using the CPAC Sync, Gas EIS, or NMEA2000 protocols, or any other suitable protocol. The TIU can provide J1708 monitoring through pins 435 using either the J1587 or any other suitable protocol. The TIU can interface to the satcom unit through an RS-132 connection 420 connected at the back of the operator module (FIGS. 1A and 2A) or operator display module (FIGS. 1B and 2B and C). The TIU can provide an RS-485 port 425 for software download, communicating to other TIUs, communicating to the operator display module (FIGS. 1B and 2B and C), and monitoring of TIU and/or satcom diagnostics. Multiple TIUs can be connected through RS-485 to provide expanded I/O and CAN bus capabilities. The TIU further comprises a set of digital I/O ports 445 and analog input ports 440 for monitoring systems such as fire, smoke, or carbon monoxide alarms, intrusion alarms, heat and air conditioning, lighting, bilge pump, battery charger, refrigeration, icemaker, live well, interior temperature, etc.

FIGS. 5A and 5B show schematically how various components of the system can be integrated. FIG. 5A shows an integrated system using an operator module without a display, as depicted in FIGS. 1A and 2A, while FIG. 5B shows an integrated system using an operator display module, as depicted in FIGS. 1B, 2B and 2C. The operator module (504 or 505) is connected to a main TIU 502 and a satcom unit 506 through RS232 connections. The main TIU 502 may be connected to other TIUs 520 or to a computer 518 through an RS485 bus. The operator display module 505 may optionally connect to other TIUs 520 or to a computer 518 through an RS485 bus, as depicted in FIG. 5B. Engine performance and diagnostic information can be communicated to the main TIU 502 either through a J1708 bus 516 or through a CAN bus 510 through a converter 508. In an alternative embodiment, the CAN bus can be connected directly to the TIU without requiring a converter. The CAN bus may connect to an electronic vessel control (EVC) 508 to provide a signal to an EVC display 512. The operator module (504 or 505) may connect to a satcom unit 506 through an RS232 connection. The satcom unit 506 in turn is connected to a satellite network over the air 507.

The invention includes a pre-install kit comprising a panel and a communications cable. The pre-install kit allows boat manufacturers to provide an option for installing a system of the invention on the boat. Customer may purchase a boat with the pre-install kit and decide for themselves whether to install the system of the invention. The pre-install kit facilitates installation of the system of the invention. Boat manufacturers may install the pre-install kit by creating a place on a newly manufactured boat for an operator module and a satcom unit, but rather than installing the operator module and satcom unit, the manufacturers may install a removable panel in place of the operator module, and a communications cable running from the removable panel to the place created for the satcom unit. Thus, when a customer opts to install the system of the invention on a pre-installed boat, all that need be done is to remove the panel, replacing it with an operator module, attach the communications cable to the operator module at element 260 in FIG. 2, install a satcom unit, and attach the communications cable to the satcom unit at element 340 in FIG. 3.

In one aspect, the invention includes an integration of the monitoring and communications functions shown in FIGS. 1-5 and described in the accompanying text with a web-based system for setting preferences, organizing information, and providing information and entertainment. The website may request information from the user such as details regarding the owner of a vessel and how the owner may be contacted and details regarding the vessel itself. Preferably, the website requires authorization to access, for example, by requiring a user identification and password to log on, and adds as secure socket layer when a user successfully logs on. Information may then be provided to authorized users of the website, in addition to such information as the subscription level, personal pictures, the location of the vessel, details about the weather or environment at the location of the vessel, details about the status of the vessel such as the voltage of the battery and the water level, and the travel history of the vessel. The website may additionally provide tools for trip planning, including means for setting way points and calculating travel times. The website may provide links to other websites for obtaining information about such things as weather and boat manufacturers, for example.

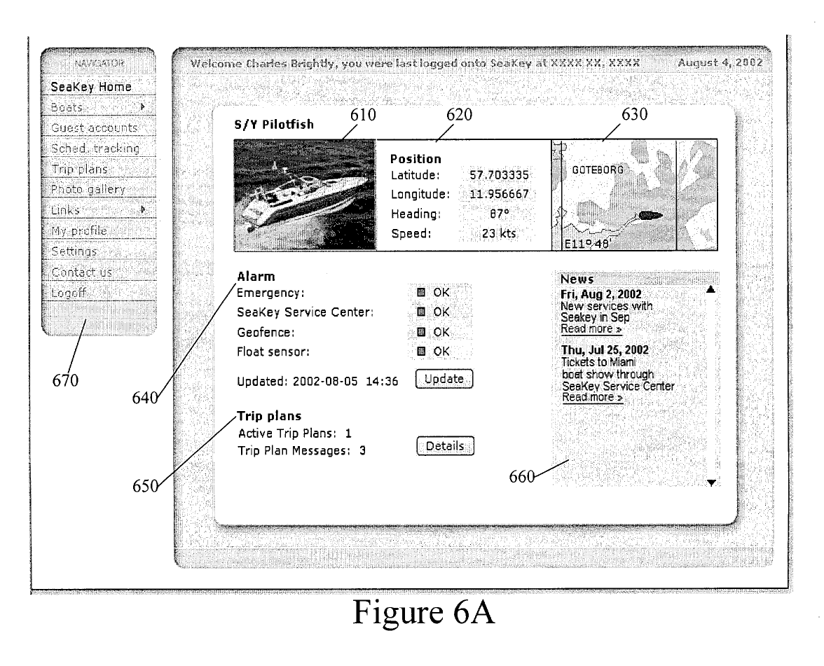

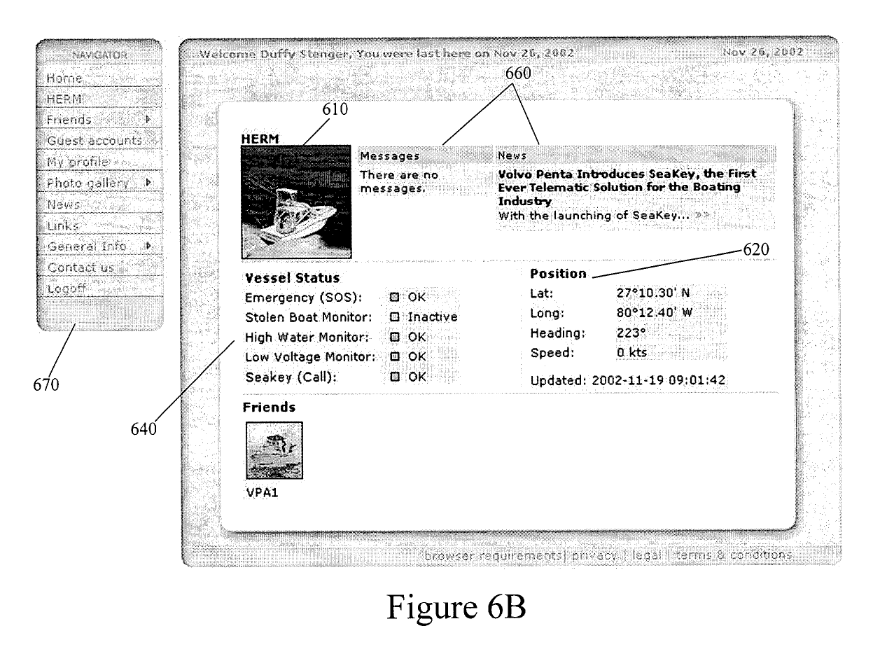

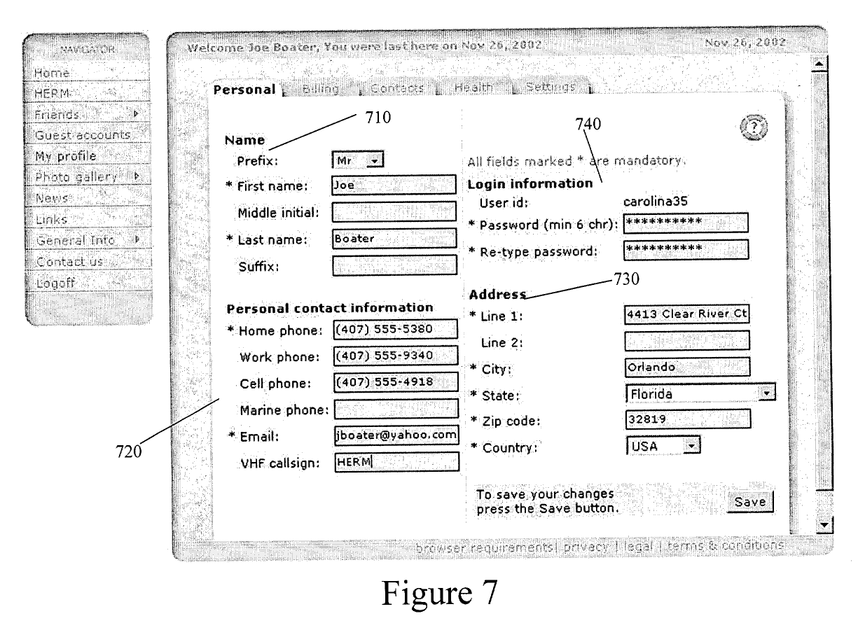

FIGS. 6A and 6B show examples of boaters' home pages. A home page may include a picture of the boat 610 that is the subject of the home page. It may further include a panel 620 showing the current position and speed of the boat. Another panel 630 may show the boat's location on a map. The home page may further include indicators 640 for each of the sensors aboard the boat, and may provide further information to the boater if any of the system sensors or alarms indicated, for example, high water, low voltage, or that the boat has left a predetermined area. The home page may further include summary information about any trips planned 650. The home page may further include a panel 660 displaying information, links, and/or advertisements that the user may find interesting. Each page in the website may include a navigation bar 670, from which the user may select a link to a page of interest to immediately bring up that page.FIG. 7 shows an example of a boater's personal profile page. The personal profile page may include text boxes for the boater to include such information as name 710, multiple points of contact 720, and address 730. Additionally, a boater may be able to change passwords 740 from the personal profile page. Similar pages may be available for a boater to provide billing information and emergency contact information, including whom to contact in case of emergency as well as information regarding any medical conditions the boater may have. The land-based system operator may then provide this information to any emergency response authority in case of a medical emergency.

The website may additionally include a page for setting up guest accounts. Guest accounts may allow users authorized by the primary account holder (usually the boat owner) to access information about the boat available through the website. For example, guest accounts may allow the boater's friends and family to track the boater's progress on voyage through tracing the boat's previous and present locations on an electronic map. The guest accounts may further allow the boater's friends and family to view photographs of previous voyages posted by the boater on the website.

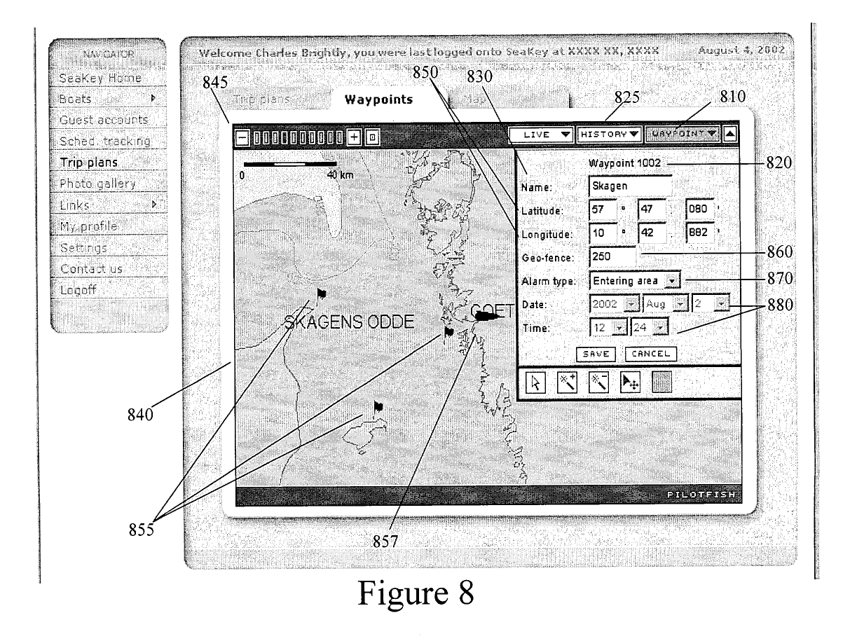

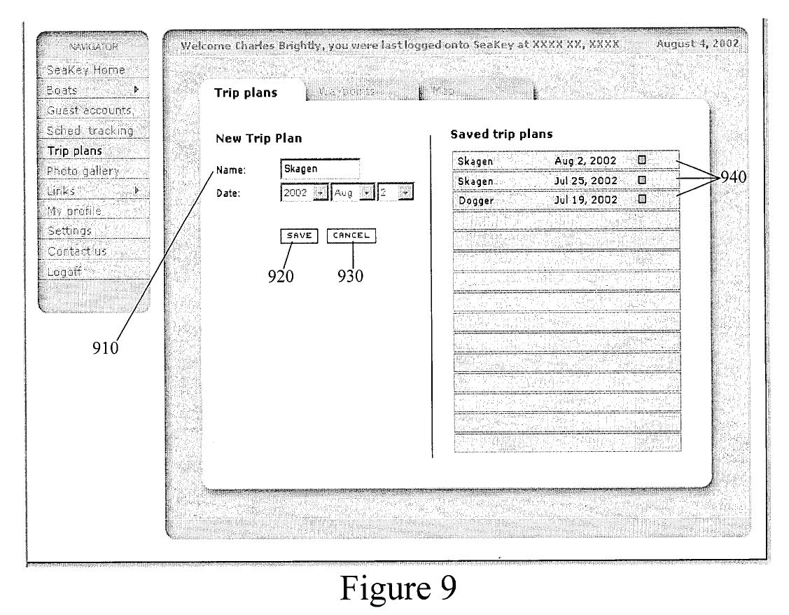

FIGS. 8 and 9 are web pages designed to facilitate planning voyages, or creating “trip plans”. FIG. 8 is the waypoints and mapping page, wherein a boater may plan a voyage by specifying particular waypoints along the route of the voyage, and may specify the time intended to reach the waypoints. The page allows a user to select a new or existing waypoint via a pull-down menu 810. The waypoint is identified in textbox 820. The name of the trip is identified in textbox 830. The user may specify the location of the waypoint by identifying the longitude and latitude of the waypoint in boxes 850. When the user has specified the longitude and latitude of the waypoint in boxes 850, a flag 855 may appear on the map 840 to indicate where the waypoint is. An icon 857 may also be provided to indicate the boat's current location. The page provides a bar 845 for zooming in and out of the map, to provide multiple levels of detail. The page further provides an option for tracing the history 825 of the boat's position so that the boater or the boater's friends and family may trace the boater's progress.

Box 860 allows the user to specify the radius of a “geofence,” to define an area around the waypoint, within which the user will be deemed to have reached the waypoint. The user may specify an action to be performed by the system when the user has reached the waypoint by selecting an option from pull-down menu 870. The page indicates the date',and time 880 that the trip plan was first created in order to distinguish it from any other trip plans with the same name. When the user has finished editing the waypoint, it may be saved by clicking the “save” button 885, or discarded by clicking the “cancel” button 890.

A set of waypoints input as described in the preceding paragraph is called a trip plan. FIG. 9 shows a webpage that allows a user to organize multiple trip plans. The page provides a text box 910 for entering or changing the name of a trip plan. The trip plan can thus be created or its name changed by entering a name in the name box 910 and clicking the “save” button 920, or the user can discard any changes by clicking the “cancel” button 930. A list of saved trip plans 940 may also be provided on this page.

A trip plan entered as described in the preceding paragraphs may be useful to a boater while on the planned voyage. The land-based center of operations may send signals to the satcom unit indicating when each of the set waypoints has been reached, and may provide additional information such as the waypoint number, or the time elapsed since passing the last waypoint.

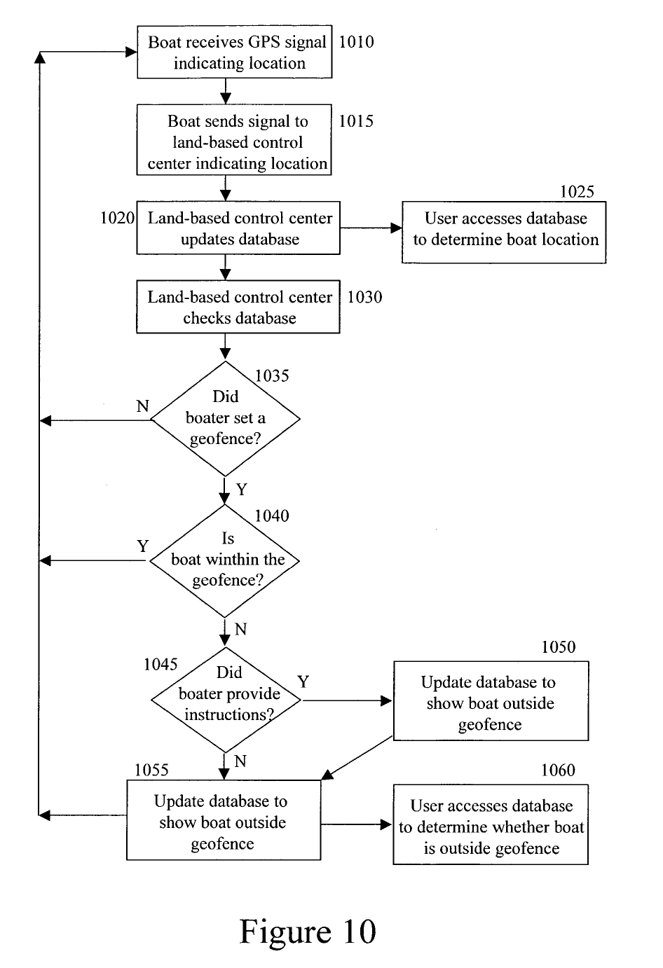

FIG. 10 is a flow diagram of one aspect of a method of the invention. In step 1010, the boat receives a GPS signal, which indicates the boat's location. This information is transmitted from the boat to a land-based control center in step 1015. The land-based control center updates a database of information about the boat including the boat's location, to reflect the boat's new location in step 1020. A user may access the database of information about the boat, for example through a website, in step 1025 to obtain the information about the boat's new location. The land-based control center checks a database 1030 to determine whether the owner set up a geofence 1035. If the owner did not set up a geofence, the cycle restarts. If the owner did set up a geofence, the control center determines whether the boat is within the geofence 1040. If the boat is within the geofence, the cycle restarts. If the boat is not within the geofence, the control center checks a database 1045 to determine whether the owner provided instructions to be carried out in the event that the boat leaves the specified geofence area. If the owner did not provide instructions, the control center updates a database to reflect the fact that the boat is outside of the geofence 1055, and the cycle restarts. If the owner did provide instructions, the control center carries out the owner's instructions 1050, and updates a database to reflect the fact that the boat is outside of the geofence 1055. A user may access the database, for example through a website, in step 1060 to determine whether the boat is outside the geofence.

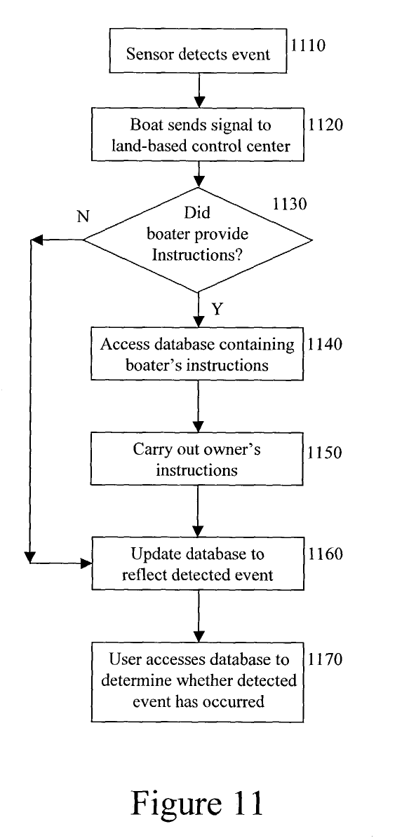

FIG. 11 is a flow diagram illustrating another aspect of a method of the invention. In step 1110, a sensor on board the boat detects a reportable event, such as high water or low battery voltage, or any other event that can be automatically detected. The boat sends a signal to the land-based control center, indicating that the detected event has occurred 1120. The land-based control center checks a database 1130 to determine whether the owner provided instructions for handling the particular event. If the owner did provide instructions, the control center accesses a database to retrieve the instructions 1140, carries out the instructions 1150, then updates a database to reflect the fact that the event has occurred and that the control center is handling the event pursuant to the owner's instructions 1160. If the owner did not provide instructions, then the control center simply updates the database to reflect the fact that the event has occurred 1160. A user, for example the boat owner, may access that database in step 1170 to determine whether the boat is taking on water or whether the battery is low, or whether any other detectable event has occurred.

While various embodiments of the invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

What is claimed is:

1. A marine telematics system comprising:
a boat with a satcom unit and an operator module to control the satcom unit;
a land-based center of operations;
a computer; and
a communications network;
wherein the land-based center of operations sends and receives signals from the satcom unit including signals indicating the location of the boat, the land-based center of operations updates a database containing information about the location of the boat, and the computer accesses the database over the communications network.

2. The marine telematics system of claim 1, wherein the land-based center of operations receives data from the computer over the communications network and provides the data to a database.

3. The marine telematics system of claim 2, wherein the data includes waypoint locations, messages, or instructions for responding to detected events.

4. The marine telematics system of claim 2, wherein the data comprises coordinates that specify a geofence.

5. The marine telematics system of claim 4, wherein the data includes instructions for responding to events on the boat detected by the system.

6. The marine telematics sytem of claim 5, wherein the events are selected from the group consisting of high water, low voltage, and boat located outside a geofence.

7. The marine telematics system of claim 6, wherein instructions are selected from the group consisting of contacting a dockmaster, contacting the boat owner or a representative of the boat owner, contacting marine towing services, and contacting an emergency response authority.

8. The marine telematics system of claim 2, further comprising a voice interface, wherein spoken messages may be transmitted between the boat and the land-based center of operations.

9. The marine telematics system of claim 2, further comprising a text message interface, wherein text messages may be transmitted between the boat and the land-based center of operations.

10. A marine telematics system comprising:
boat-based means for receiving signals indicating a position of a boat;
land-based means for receiving signals from boat-based means, wherein the signals indicate the position of the boat; and
means for sending and receiving data to and from a remote user, wherein the data includes instructions for responding to events detected by the system and the position of the boat.

11. The marine telematics system of claim 10, wherein the data comprises waypoint locations, messages, or instructions for responding to detected events.

12. The marine telematics system of claim 10, wherein the data comprises coordinates that specify a geofence.

13. The marine telematics system of claim 10, wherein the events are selected from the group consisting of high water, low voltage, and boat located outside a geofence.

14. The marine telematics system of claim 13, wherein the instructions are selected from the group consisting of contacting a dockmaster, contacting the boat owner or a representative of the boat owner, contacting marine towing services, and contacting an emergency response authority.

15. A method for providing telematics services to boaters comprising:
receiving signals at a land-based center of operations from a boat, wherein the boat is equipped with a satcom unit, and the signals include information about a position of the boat;
sending signals from the land-based center of operations to the boat, wherein the signals indicate that the signals from the boat have been received by the land-based center of operations;
updating a database containing information about the position of the boat.

16. The method of claim 15, further comprising receiving data from a remote user, wherein the data includes instructions for responding to an event on the boat detected by at least one sensor.

17. The method of claim 15, further comprising receiving data from a remote user, wherein the data indicates coordinates of waypoints, messages, or instructions for responding to detected events.

18. The method of claim 15, further comprising receiving data from a remote user, wherein the data indicates coordinates of a geofence.

19. The method of claim 16, wherein the events are selected from the group consisting of high water, low voltage, and boat located outside a geofence.

20. The method of claim 19, wherein instructions are selected from the group consisting of contacting a dockmaster, contacting the boat owner, and contacting an emergency response authority.

21. The method of claim 15, further comprising transmitting spoken messages between the boat and the land-based center of operations.

22. The method of claim 15, further comprising transmitting text messages between the boat and the land-based center of operations

23. A marine telematics system comprising:
a boat with a satcom unit and an operator module to control the satcom unit; and
a land-based center of operations;
wherein the land-based center of operations sends and receives signals from the satcom unit including signals indicating the location of the boat and communications signals, and the land-based center of operations updates a database containing information about the location of the boat and the communications signals.

24. The marine telematics system of claim 23, wherein the communications signals include information about events detected on the boat.

25. The marine telematics system of claim 23, further comprising a voice interface, wherein the communications signals are spoken messages transmitted between the boat and the land-based center of operations.

26. The marine telematics system of claim 23, further comprising a text interface, wherein the communications signals are text messages transmitted between the boat and the land-based center of operations.

27. A pre-install kit for a marine telematics system comprising a removable operator module panel, a satcom unit mounting pad, and a communications cable, wherein the removable operator module panel is installed on a boat in a location for an operator module to control a satcom unit, and the communications cable extends from the removable panel to a location on the boat for the satcom unit, and the satcom mounting pad is installed on the boat in a location for a satcom unit.
